(19) United States
(12) Patent Application Publication
(10) Pub. No.: US 2026/0311698 A1
(43) Pub. Date: Oct. 8, 2026

(54) INFORMATION PROCESSING DEVICE AND STORAGE MEDIUM

(71) Applicant: TOYOTA JIDOSHA KABUSHIKI KAISHA, Toyota-shi (JP)

(72) Inventors: Aya YAMADA KAMISAKA, Tokyo (JP); Hajime TOJIKI, Tokyo (JP); Ryota NAKANISHI, Tokyo (JP); Kota HOSHIBA, Tokyo (JP); Takayuki YAMABE, Tokyo (JP)

(73) Assignee: TOYOTA JIDOSHA KABUSHIKI KAISHA, Toyota-shi (JP)

(21) Appl. No.: 19/530,624

(22) Filed: Feb. 5, 2026

(30) Foreign Application Priority Data
Apr. 3, 2025 (JP) 2025-061915

(51) Int. Cl. G10L 15/22

(52) U.S. Cl. CPC G10L 15/22; G10L 2015/227

(57) ABSTRACT

An information processing device according to a first aspect of the present disclosure is configured to: acquire conversation data that is a record of conversation held among a plurality of users; analyze the acquired conversation data to determine rankings of initiative in the conversation among the users; when requests are received from at least two users out of the plurality of users concurrently, determine priority levels of the received requests based on results of determination of the rankings; and cause an agent to process the requests in accordance with the determined priority levels.

### CROSS-REFERENCE TO RELATED APPLICATION

This application claims priority to Japanese Patent Application No. 2025-061915 filed on Apr. 3, 2025. The disclosure of the above-identified application, including the specification, drawings, and claims, is incorporated by reference herein in its entirety.

### BACKGROUND

### 1. Technical Field

The present disclosure relates to an information processing device and a storage medium storing a program.

### 2. Description of Related Art

Japanese Unexamined Patent Application Publication No. 2016-103081 (JP 2016-103081 A) proposes a wearable terminal including a keyword database, a topic word database, a microphone, and a camera. The proposed wearable terminal recognizes topic words and keywords from speech information, recognizes the duration of a conversation partner's smile and the number of times he/she nods per unit conversation time from video, analyzes the conversation partner's receptivity to the conversation and his/her conversational skill from the speech and video recognition results, and provides feedback on the receptivity and the conversational skill to the user. WO 2019/097674 proposes a device that analyzes an interpersonal relationship between occupants.

### SUMMARY

An object of the present disclosure is to provide a technology for processing, in an appropriate order, requests received from two or more users concurrently.

An information processing device according to a first aspect of the present disclosure includes a control unit. The control unit is configured to execute: acquiring conversation data that is a record of conversation held among a plurality of users; analyzing the acquired conversation data to determine rankings of initiative in the conversation among the users; when requests are received from at least two users out of the plurality of users concurrently, determining priority levels of the received requests based on results of determination of the rankings; and causing an agent to process the requests in accordance with the determined priority levels.

A storage medium storing a program according to a second aspect of the present disclosure is a storage medium storing a program for causing a computer to execute an information processing method. The information processing method includes: acquiring conversation data that is a record of conversation held among a plurality of users; analyzing the acquired conversation data to determine rankings of initiative in the conversation among the users; when requests are received from at least two users out of the plurality of users concurrently, determining priority levels of the received requests based on results of determination of the rankings; and causing an agent to process the requests in accordance with the determined priority levels. A trained machine learning model may be used to receive the requests and/or process the received requests.

According to the present disclosure, it can be expected that requests received from two or more users concurrently are processed in an appropriate order.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically illustrates an example of a situation in which the present disclosure is applied;

FIG. 2 schematically illustrates an example of analysis elements of conversation data;

FIG. 3 schematically illustrates an example of a method for determining priority levels;

FIG. 4 schematically illustrates an example of a hardware configuration of an information processing device;

FIG. 5 is a flowchart illustrating an example of processing procedures related to ranking; and

FIG. 6 is a flowchart illustrating an example of processing procedures related to request processing.

### DETAILED DESCRIPTION OF EMBODIMENTS

In recent years, technological developments have progressed in agents that receive requests uttered by users and process the received requests. The agents are configured by trained machine learning models such as large-scale generative models. With this agent technology, various types of uttered request can be processed. However, the present inventors have found that the related-art agent technology has the following problem. That is, when two or more users give requests to the agent concurrently, the requests may conflict with each other. When there is a conflict over reception of requests, the requests may be processed in an inappropriate order as in a case where a request that may be processed later is processed first.

In view of the above, an information processing device according to a first aspect of the present disclosure includes a control unit. The control unit is configured to execute: acquiring conversation data that is a record of conversation held among a plurality of users; analyzing the acquired conversation data to determine rankings of initiative in the conversation among the users; when requests are received from at least two users out of the plurality of users concurrently, determining priority levels of the received requests based on results of determination of the rankings; and causing an agent to process the requests in accordance with the determined priority levels.

In the first aspect of the present disclosure, the rankings of initiative in the conversation among the users are determined based on the conversation held among the users. When the requests are received from two or more users concurrently, the priority levels of the received requests are determined based on the results of determination of the rankings. The received requests are processed in accordance with the determined priority levels (i.e., the requests are processed in descending order of the priority levels). With the initiative in the conversation, the level of dominance over the conversation space for each user can be evaluated. It is presumed that a person with a higher level of dominance over the conversation space is more likely to make a key utterance and is thus more likely to give an important request to the agent (more likely to take the lead in making an important request). That is, it is presumed that, as the user has a higher initiative level, the importance of the request given by the user increases. According to the first aspect of the present disclosure, the results of determination of the rankings of initiative in the conversation are used based on this perspective. Therefore, when the requests are received from two or more users concurrently, the priority levels of the requests received from the users can be determined appropriately. As a result, it can be expected that the requests received from the two or more users concurrently are processed in an appropriate order.

The embodiment of the present disclosure is not limited to the information processing device. As other forms of the information processing device according to the above aspect, one aspect of the present disclosure may be at least one of an information processing method that implements at least part of the above components, a program, and a storage medium that stores the program and is readable by a machine such as a computer. The machine-readable storage medium may be a non-transitory medium that stores information such as a program by electrical, magnetic, optical, mechanical, or chemical action. The non-transitory storage medium may include a storage medium (CD, DVD, semiconductor memory, etc.), an auxiliary storage device of a computer, an external storage device connected to a computer, etc.

For example, a program according to a second aspect of the present disclosure may be a program for causing a computer to execute an information processing method. The information processing method may include: acquiring conversation data that is a record of conversation held among a plurality of users; analyzing the acquired conversation data to determine rankings of initiative in the conversation among the users; when requests are received from at least two users out of the plurality of users concurrently, determining priority levels of the received requests based on results of determination of the rankings; and causing an agent to process the requests in accordance with the determined priority levels.

For example, an information processing method according to a third aspect of the present disclosure may be executed by a computer. The information processing method may include: acquiring conversation data that is a record of conversation held among a plurality of users; analyzing the acquired conversation data to determine rankings of initiative in the conversation among the users; when requests are received from at least two users out of the plurality of users concurrently, determining priority levels of the received requests based on results of determination of the rankings; and causing an agent to process the requests in accordance with the determined priority levels.

Hereinafter, an embodiment according to one aspect of the present disclosure will be described with reference to the drawings. However, the present embodiment described below is merely illustrative of the present disclosure in all respects. Various modifications or variations may be made without departing from the scope of the present disclosure. In implementing the present disclosure, specific configurations according to the embodiment may be adopted as appropriate. Data appearing in the present embodiment is described in natural language. More specifically, the data is specified in pseudo-language, commands, parameters, machine language, electrical signals, etc. that can be recognized by machines such as computers.

### 1. Application Example

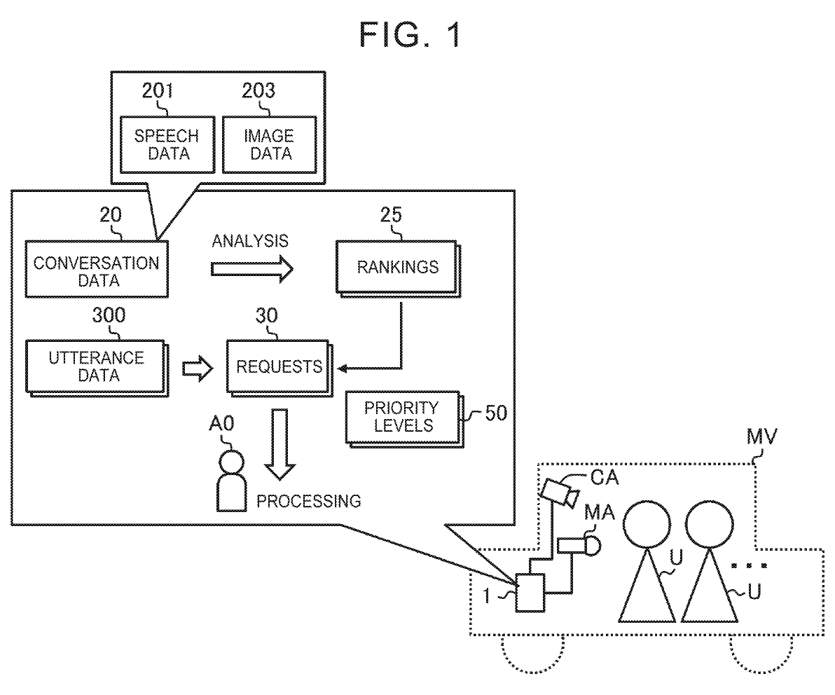

FIG. 1 schematically illustrates an example of a situation in which the present disclosure is applied. An information processing device 1 according to the present embodiment is one or more computers configured to cause an agent to process a request received from a user.

In the present embodiment, the information processing device 1 acquires conversation data 20 that is a record of conversation held among a plurality of users U. The information processing device 1 analyzes the acquired conversation data 20 to determine rankings 25 of initiative in the conversation among the users U. The information processing device 1 receives uttered requests 30 and causes an agent A0 to process the received requests 30. The information processing device 1 may receive the requests 30 from at least two users U out of the plurality of users U concurrently. When the information processing device 1 receives the requests 30 from at least two users U out of the plurality of users U concurrently, the information processing device 1 determines priority levels 50 of the received requests 30 based on results of determination of the rankings 25. The information processing device 1 causes the agent A0 to process the requests 30 in accordance with the determined priority levels 50. That is, the information processing device 1 causes the agent A0 to process the requests 30 in descending order of the priority levels 50.

The method for receiving the request 30 is not particularly limited, and may be selected as appropriate depending on the embodiment. A known method may be adopted as the method for receiving the request 30. In one example, the information processing device 1 may acquire utterance data 300 indicating utterance recorded by a microphone MA. The information processing device 1 may identify the utterance content by performing speech analysis on the acquired utterance data 300. The information processing device 1 may determine whether the identified utterance content includes the request 30 by performing language analysis. Known methods may be adopted as the methods for the speech analysis and the language analysis. With a large-scale generative model such as a large-scale speech model, the speech analysis and the language analysis may be performed in a unified process. When the utterance content includes the request 30, the information processing device 1 may give the request 30 to the agent A0 and cause the agent A0 to process the request 30.

As described above, it is presumed that, as the user U has a higher initiative level, the importance of the request 30 given by the user U increases. According to the present embodiment, the results of determination of the rankings 25 of initiative in the conversation are used based on this perspective. Therefore, when the requests 30 are received from two or more users U concurrently, the priority levels 50 of the requests 30 received from the users U can be determined appropriately. As a result, it can be expected that the requests 30 received from the two or more users U concurrently are processed in an appropriate order.

### User

The user U may be any person who can give the request 30 to the agent A0. The user U may be either a real entity or a virtual entity. Examples of the virtual entity may include robots and video characters. The situation in which the request 30 is received from the user U is not particularly limited, and may be selected as appropriate depending on the embodiment. In one example, the information processing device 1 may receive requests 30 from users U inside a vehicle MV. In this case, the users U may include at least one of a driver and a passenger. The type of the vehicle MV (number of wheels, power source, size, etc.) may be selected optionally. The vehicle MV may include manually driven vehicles and autonomous vehicles.

### Agent

The agent A0 may be configured by an application for processing the request 30. The processing of the request 30 may mean execution of information processing in response to the request 30. The information processing in response to the request 30 may include any type of information processing that can be executed by a computer. As long as the agent A0 can process the request 30, the configuration of the agent A0 is not particularly limited, and may be selected as appropriate depending on the embodiment. In one example, the agent A0 may be configured by a computational model such as a rule-based model or a trained machine learning model. The rule-based model is configured to derive an inference result (such as a result of processing of the request 30) from a given input in accordance with rules. The rules may be given as appropriate. The rule-based model may include an expert system. The machine learning model has one or more computational parameters that can be adjusted by machine learning. The one or more computational parameters are used for computing desired inference (such as processing of the request 30). The machine learning model may be configured, for example, by a neural network, a regression model, a decision tree model, a support vector machine, or any other functional expression. The machine learning method may be selected as appropriate depending on the machine learning model to be adopted (e.g., backpropagation). The trained machine learning models may include large-scale generative models such as large-scale language models, large-scale visual language models, and large-scale speech models. A known agent may be used as the agent A0.

The agent A0 may be deployed on the information processing device 1 or on a computer other than the information processing device 1. When the agent A0 is deployed in another computer, the information processing device 1 may be connected to the other computer as appropriate. The information processing device 1 may cause the agent A0 to process the request 30 by giving the received request 30 to the other computer. The information processing device 1 may acquire the result of processing of the request 30 by the agent A0 from the other computer.

### Conversation Data

As long as the conversation data 20 includes a record of conversation held among the users U, the configuration of the conversation data 20 is not particularly limited, and may be selected as appropriate depending on the embodiment. In one example, the record of conversation may include speech and images. For example, the microphone MA and an imaging device CA may be installed in a conversation space of the users U. As a specific example, in a situation in which the request 30 is received inside the vehicle MV, the vehicle MV may include a driver monitoring system including a microphone and an imaging device. The microphone and the imaging device of this driver monitoring system may be used as at least part of the microphone MA and imaging device CA. However, the method for installing the microphone MA and the imaging device CA is not limited to this example. A microphone and an imaging device other than those of the driver monitoring system may be used as the microphone MA and the imaging device CA. The microphone MA and the imaging device CA may be installed optionally. The number of microphones MA and imaging devices CA may be selected optionally. The information processing device 1 may acquire speech data 201 and image data 203 directly from the microphone MA and the imaging device CA, or may acquire them indirectly via a storage medium etc. The conversation data 20 may be composed of the acquired speech data 201 and the acquired image data 203. The speech data 201 may be used in a voice file format, or may be used after being converted into a text file format by speech analysis.

The speech and images represent the content and context of conversation. Since the conversation record includes speech and images in one example of the present embodiment, it can be expected that analysis related to initiative described later can be performed appropriately. However, the configuration of the conversation data 20 is not limited to this example, and may be changed as appropriate depending on the embodiment. In another example, the conversation data 20 may be composed only of the speech data 201. The conversation data 20 may further include any data other than the speech data 201 and the image data 203.

### Analysis Elements of Conversation Data

The initiative in conversation corresponds to the level of dominance over the conversation space. A more dominant user U has a higher ranking 25 of initiative, and a more subordinate user U has a lower ranking 25 of initiative. As long as such ranking is possible, the analysis elements of the conversation data 20 are not particularly limited, and may be selected as appropriate depending on the embodiment.

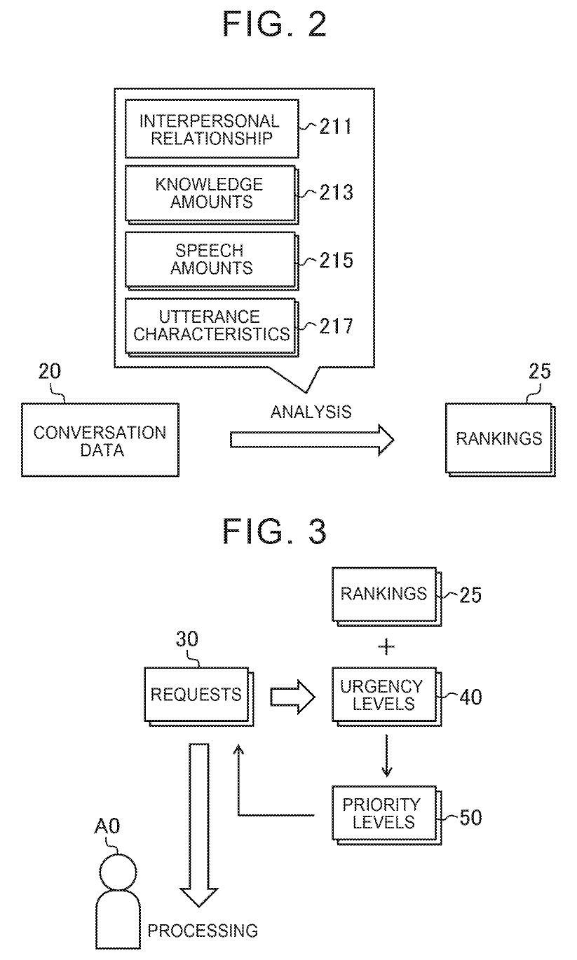

FIG. 2 schematically illustrates an example of the analysis elements of the conversation data 20 according to the present embodiment. In one example, the analysis of the conversation data 20 may include analysis of at least one of an interpersonal relationship 211 between the users U appearing in the conversation data 20, knowledge amounts 213 of the users U, speech amounts 215 of the users U, and utterance characteristics 217 of the users U. Accordingly, the rankings 25 of initiative in the conversation among the users U may be determined based on at least one of the analyzed interpersonal relationship 211, the analyzed knowledge amounts 213, the analyzed speech amounts 215, and the analyzed utterance characteristics 217.

Each element may be analyzed by any method. In one example, each element may be analyzed using a computational model such as a rule-based model or a trained machine learning model. The trained machine learning model may include a large-scale generative model. A known analysis method may be adopted to analyze each element. For example, the information processing device 1 may identify each user U appearing in the conversation data 20. A known method such as voiceprint recognition or facial image recognition may be adopted as the method for identifying the user U. The information processing device 1 may analyze each element from the data of each identified user U included in the conversation data 20.

The interpersonal relationship 211 indicates a relationship between the users U. The type of the interpersonal relationship 211 may be defined as appropriate depending on the embodiment. In one example, the type of the interpersonal relationship 211 may include a family relationship, a friendship, or a business relationship. The family relationship may include, for example, a parent-child relationship, a husband-wife relationship, or kinship. The business relationship may include, for example, a boss-subordinate relationship, colleagues, or clients.

The information processing device 1 may identify an utterance period of each user U in the conversation data 20 from the result of identification of each user U, and acquire the utterance content of each user U from the identified utterance period. The information processing device 1 may identify the utterance characteristic 217 of each user U from the acquired utterance content. When the conversation data 20 includes the image data 203, the information processing device 1 may estimate attributes such as the age and gender of each user U from the image data 203. The information processing device 1 may use a computational model (rule-based model, trained machine learning model, etc.) to estimate the interpersonal relationship 211 between the users U based on at least one of the utterance contents, the utterance characteristics 217, and the attributes of the users U. The method for analyzing the interpersonal relationship 211 is not limited to this example, and may be changed as appropriate depending on the embodiment. A known method such as that in WO 2019/097674 may be adopted as the method for analyzing the interpersonal relationship 211.

The interpersonal relationship 211 and the ranking relationship may be defined as appropriate. For example, when there is a hierarchical relationship in the interpersonal relationship 211, such as a relationship of a parent and a child or a relationship of a boss and a subordinate, it is presumed that a user U in a higher position of hierarchy is more likely to dominate the conversation space than a user U in a lower position of hierarchy. Therefore, in one example, when other elements are not taken into consideration, the rankings 25 of the users U may be determined such that the user U in a higher position of hierarchy has a higher ranking 25 and the user U in a lower position of hierarchy has a lower ranking 25. When the interpersonal relationship 211 is an equal relationship, the rankings 25 of the users U may be determined such that the rankings 25 of users U in the equal relationship are equal to each other. Depending on attributes such as age and gender, the rankings 25 may differ between the users U in the equal relationship.

The information processing device 1 may store the result of analysis (estimation) of the interpersonal relationship 211 in a database in association with the results of identification of the users U. The database may be stored in a memory resource of the information processing device 1 or in an external storage device. For example, the information processing device 1 may assign a unique identifier to each user U. The information processing device 1 may extract data (voiceprint data, facial image data, etc.) that can be used for identifying the user U from the data of each identified user U included in the conversation data 20. The information processing device 1 may store the identifier of the target user U, the data that can be used for identification, and the result of analysis of the interpersonal relationship 211 in the database. In the subsequent processing, the information processing device 1 may identify each user U by referring to various types of data stored in the database, thereby identifying the interpersonal relationship 211 between the users U. Thus, it can be expected that the interpersonal relationship 211 is analyzed at higher speed.

The knowledge amount 213 indicates the level of knowledge. The knowledge amount 213 may be evaluated as a discrete value or a continuous value. In a simple example, the knowledge amount 213 may be evaluated as a binary value (presence or absence of knowledge). The knowledge amount 213 may be evaluated in a specific domain or without domain restrictions. The domain may be defined by conversation conditions such as the conversation environment and the types of requests 30 that can be received. For example, target terms for evaluating the knowledge amount 213 may be defined in advance. The target terms may include, for example, technical terms and related terms. The list of target terms may be held in the memory resource of the information processing device 1, or may be incorporated into a program (program 81 described later). The information processing device 1 may count the number of target terms included in the utterance content of each identified user U. The information processing device 1 may identify the knowledge amount 213 of each user U based on the number of counted target terms. In another example, the information processing device 1 may give the utterance content of each user U and an estimation instruction to the large-scale generative model to cause the large-scale generative model to estimate the knowledge amount 213 of each user U. When the knowledge amount 213 is evaluated in a specific domain, the estimation instruction given to the large-scale generative model may include specifying of the domain in which the knowledge amount 213 is evaluated.

The relationship between the knowledge amount 213 and the ranking may be defined as appropriate. It is presumed that a user U with a large knowledge amount 213 is more likely to dominate the conversation space than a user U with a small knowledge amount 213. Therefore, in one example, when other elements are not taken into consideration, the rankings 25 of the users U may be determined such that the user U with a large knowledge amount 213 has a higher ranking 25 and the user U with a small knowledge amount 213 has a lower ranking 25.

The speech amount 215 indicates the amount of speech in conversation. The speech amount 215 may be evaluated as a discrete value or a continuous value. For example, the information processing device 1 may identify the speech amount 215 of each identified user U based on at least one of the number of characters in the utterance of the user U, the number of words in the utterance, and the utterance duration.

The relationship between the speech amount 215 and the ranking may be defined as appropriate. It is presumed that a user U with a large speech amount 215 is more likely to dominate the conversation space than a user U with a small speech amount 215. Therefore, in one example, when other elements are not taken into consideration, the rankings 25 of the users U may be determined such that the user U with a large speech amount 215 has a higher ranking 25 and the user U with a small speech amount 215 has a lower ranking 25.

The utterance characteristic 217 indicates the characteristic of utterance. The utterance characteristic 217 may include, for example, tone, inflection, or an utterance rate. The tone may include the manner of speaking, such as whether honorific language is used. As described above, the utterance characteristic 217 may be used for analyzing the interpersonal relationship 211. The utterance characteristic 217 may reflect the interpersonal relationship 211. Therefore, when determining the rankings 25, the results of analysis of the utterance characteristics 217 may be used in the same way as that of the interpersonal relationship 211. For example, when other elements are not taken into consideration, the rankings 25 of the users U may be determined such that a user U estimated in a higher position of hierarchy based on the utterance characteristic 217 has a higher ranking 25 and a user U estimated in a lower position of hierarchy has a lower ranking 25.

The level of dominance over the conversation space can be appropriately evaluated based on the interpersonal relationship 211, the knowledge amounts 213, the speech amounts 215, and the utterance characteristics 217. Since at least one of the interpersonal relationship 211, the knowledge amounts 213, the speech amounts 215, and the utterance characteristics 217 is used in one example of the present embodiment, it is possible to expect appropriate ranking of initiative levels in the conversation.

The collection of the conversation data 20 may or may not at least partially overlap the reception of requests 30. That is, the conversation data 20 may or may not at least partially overlap the utterance data 300 including the request 30. The information processing device 1 may continue to collect the conversation data 20 while continuing to receive requests 30, thereby continuing to update the rankings 25 of initiative in the conversation in real time. In one example, the results of determination of the rankings 25 may directly indicate the rankings 25, or may indirectly indicate the rankings 25 based on the initiative levels in the conversation, etc. In one simple example, the results of determination of the rankings 25 may be expressed by binary values of initiative.

### Request

The type of the request 30 is not particularly limited, and may be selected as appropriate depending on the embodiment. The request 30 may include, for example, information search (including a question), task management, machine control, or application control. The information search may include a question. The task management may include setting of alerts or timers, registration or checking on schedules, or creation of a to-do list. The object of the machine control may be selected optionally. For example, when the request 30 is received inside the vehicle MV, the machine control may include control on the vehicle MV, such as steering of a steering wheel of the vehicle MV, accelerator operation, brake operation, turn signal operation, wiper operation, air conditioning operation, ON or OFF of lights, or communication processing. The application control may include, for example, playing or stopping of contents or activation or termination of a target application. The application control may include, for example, adjustment of the volume or adjustment of the screen brightness. For example, in a situation in which the request 30 is received inside the vehicle MV, the vehicle MV may include a navigation device. The information processing device 1 may be the navigation device or may be connected to the navigation device. In this case, the application control may include control on the navigation device, such as setting of a destination, route guidance, checking on travel time, and searching for nearby facilities.

### Concurrence

The concurrent reception of requests 30 means reception of requests 30 at a timing that may cause a conflict as in a case where requests 30 are received simultaneously. For example, the concurrence range may be defined as a time range in which the processing of requests 30 received from two or more users U may overlap.

### Priority Level

The priority levels 50 determine the order of processing of two or more requests 30 received concurrently. A request 30 with a higher priority level 50 is processed first. The priority levels 50 of the requests 30 may be determined as appropriate depending on the results of determination of the rankings 25 of initiative in the conversation. For example, the priority levels 50 of the requests 30 from the users U may be determined such that a user U with a higher ranking 25 of initiative in the conversation (i.e., a higher initiative level in the conversation) has a higher priority level 50 of the request 30 and a user U with a lower ranking 25 has a lower priority level 50 of the request 30. The priority level 50 may be determined based on the ranking 25 alone, or may be determined by further referring to information other than the ranking 25.

FIG. 3 schematically illustrates an example of the method for determining the priority levels 50 according to the present embodiment. In one example, the information processing device 1 may determine urgency levels 40 of received request 30. The determination of the priority levels 50 of the received requests 30 based on the results of determination of the rankings 25 may be the determination of the priority levels 50 of the received requests 30 based on the results of determination of the rankings 25 and the results of determination of the urgency levels 40. The urgency level 40 is an example of other information.

The urgency level 40 may be determined as appropriate from the utterance of the request 30. The urgency level 40 may be determined using a computational model such as a rule-based model or a trained machine learning model. The trained machine learning model may include a large-scale generative model. For example, the urgency level 40 of the request 30 may be determined depending on whether a specific term is included in the utterance content of the request 30. When the utterance of the request 30 includes a term related to urgency, such as a word indicating urgency (such as "priority") or a word indicating a highly urgent process, the urgency level 40 of the request 30 may be determined to be high. When the utterance of the request 30 does not include the term related to urgency, the urgency level 40 may be determined to be low. The highly urgent process may be set as appropriate depending on the embodiment.

The ranking 25 and the urgency level 40 may be reflected as appropriate in the determination of the priority level 50. In one example, the information processing device 1 may reflect the ranking 25 and the urgency level 40 in the determination of the priority level 50 without superiority or inferiority. In another example, the information processing device 1 may prioritize either the ranking 25 or the urgency level 40, and reflect the prioritized index in the determination of the priority level 50. For example, the information processing device 1 may determine the priority level 50 of the request 30 such that the priority level 50 increases as the urgency level 40 increases, and the priority level 50 decreases as the urgency level 40 decreases. When the urgency levels 40 are equal to each other, the information processing device 1 may determine the priority levels 50 of the requests 30 such that the priority level 50 increases as the request 30 is given by a user U with a higher ranking 25, and the priority level 50 decreases as the request 30 is given by a user U with a lower ranking 25. Since the urgency levels 40 of the requests 30 are further reflected in the determination of the priority levels 50 in addition to the rankings 25 of initiative in the conversation in one example of the present embodiment, it can be expected that the requests 30 received from two or more users U concurrently are processed in a more appropriate order.

### 2. Configuration Example

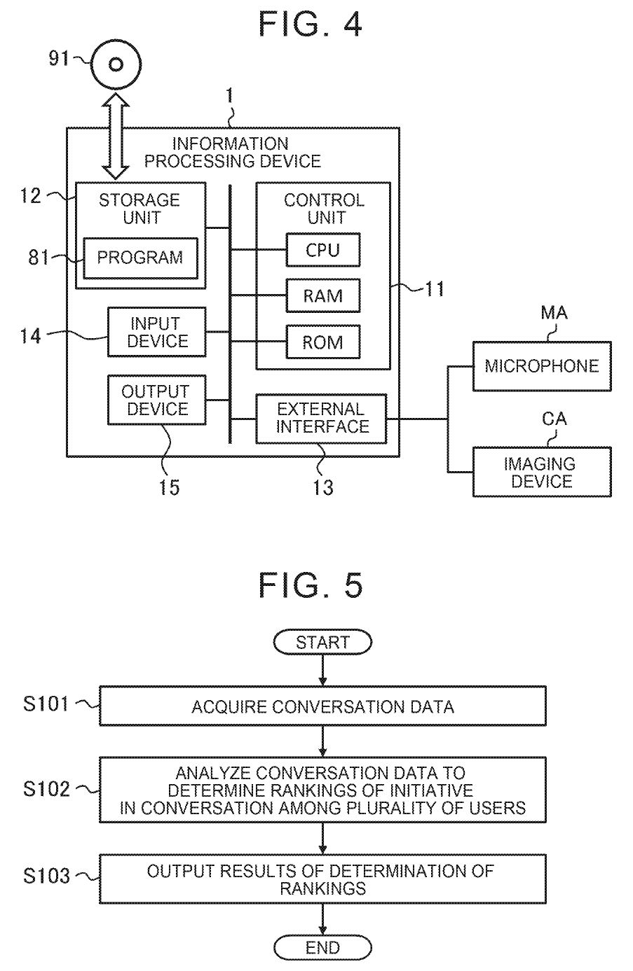

FIG. 4 schematically illustrates an example of a hardware configuration of the information processing device 1 according to the present embodiment. In one example, the information processing device 1 may be configured as a computer in which a control unit 11, a storage unit 12, an external interface 13, an input device 14, and an output device 15 are electrically connected.

The control unit 11 is configured to execute information processing based on programs and various types of data. For example, the control unit 11 may include a central processing unit (CPU) that is a hardware processor, a random access memory (RAM), and a read only memory (ROM). The control unit 11 (CPU) is an example of a processor resource.

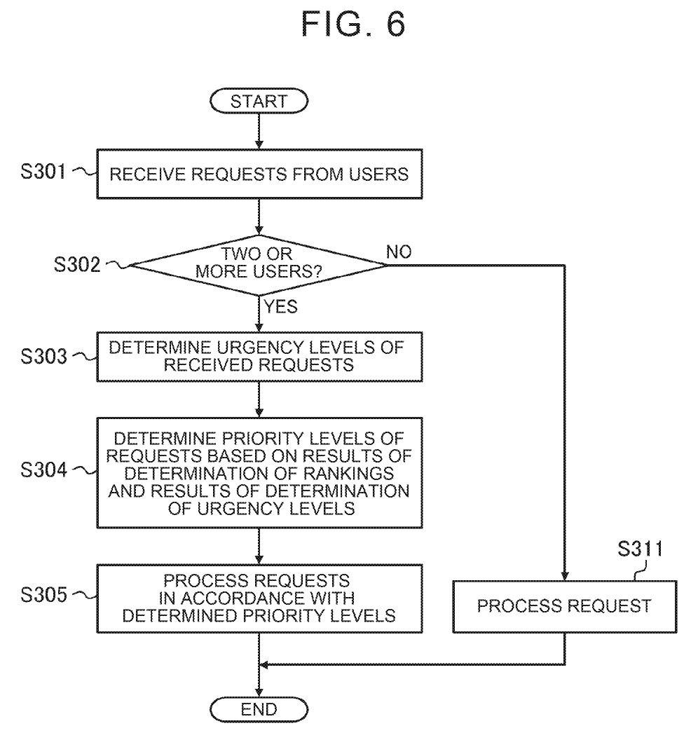

The storage unit 12 is configured to hold any data. For example, the storage unit 12 may include a hard disk drive, a solid state drive, and a semiconductor memory. The storage unit (and RAM, ROM) is an example of the memory resource. In one example, the storage unit 12 may store various types of information such as the program 81. The program 81 is a program for causing the information processing device 1 to execute information processing (FIGS. 5 and 6 described later) related to the processing of requests 30 by the agent A0. The program 81 includes a series of commands for this information processing.

In one example, the program 81 may be stored in a storage medium 91 instead of or together with the storage unit 12. The storage medium 91 is configured to store various types of information (stored programs etc.) by electrical, magnetic, optical, mechanical, or chemical action such that the information can be read by a machine such as a computer. The storage unit 12 and the storage medium 91 are examples of a non-transitory storage medium. The information processing device 1 may acquire the program 81 from the storage medium 91. The storage medium 91 may be a disc storage medium (CD, DVD, etc.) or may be a non-disc storage medium such as a semiconductor memory (flash memory etc.). Any drive device may be used for reading the information stored in the storage medium 91. The type of the drive device may be selected depending on the storage medium 91. The drive device may be connected to the information processing device 1 by any method. The storage medium 91 may include an external storage device connectable to the information processing device 1.

When the agent A0 is deployed in the information processing device 1, the data of the agent A0 may be stored in the memory resource such as the storage unit 12 or may be incorporated into the program 81. When a computational model is used for each process, the data of the computational model may be stored in the memory resource such as the storage unit 12 or may be incorporated into the program 81. When the result of analysis of the interpersonal relationship 211 is stored as past history in the database provided in the information processing device 1, the database may be stored in the memory resource such as the storage unit 12.

The external interface 13 is configured to connect to an external device by wire or by wireless. The external interface 13 may be, for example, a universal serial bus (USB) port, a dedicated port, or a communication port. The type of the external interface 13 and the number of external interfaces 13 may be determined as appropriate depending on the embodiment. When the external interface 13 includes the communication port, the standard of the communication network may be selected optionally. The information processing device 1 may be connected to at least one of the microphone MA and the imaging device CA via the external interface 13.

The input device 14 is configured to receive input of information. The input device 14 may be configured, for example, by a mouse, a keyboard, a touch panel, a touch pad, or an operator. The output device 15 is configured to output information. The output device 15 may be configured, for example, by a display or a speaker. The information processing device 1 may be operated using the input device 14 and the output device 15. The input device 14 and the output device 15 may be directly connected to the information processing device 1 or may be indirectly connected via the external interface 13. The input device 14 and the output device 15 may be at least partially integrated into one device such as a touch panel display.

Regarding the specific hardware configuration of the information processing device 1, components may be omitted, replaced, or added as appropriate depending on the embodiment. For example, the control unit 11 may include a plurality of hardware processors. The hardware processor may be a microprocessor, a field-programmable gate array (FPGA), a digital signal processor (DSP), an electronic control unit (ECU), a graphics processing unit (GPU), an application specific integrated circuit (ASIC), etc. At least one of the external interface 13, the input device 14, and the output device 15 may be omitted. The program 81 may be stored in an external storage device such as a network attached storage (NAS). The external storage device is also an example of the non-transitory storage medium. The information processing device 1 may be configured by a plurality of computers. In this case, the hardware configurations of the computers may or may not be the same. The information processing device 1 may be a computer designed to be specific to a service to be provided, a general-purpose server device, a general-purpose personal computer (PC), a notebook PC, a terminal device, etc. The terminal device may include a user terminal such as a mobile phone (smartphone etc.) or a tablet terminal. In the case of the vehicle MV, the terminal device may include an on-board terminal.

### 3. Operation Example

FIG. 5 is a flowchart illustrating an example of processing procedures related to ranking to be performed by the information processing device 1 according to the present embodiment. FIG. 6 is a flowchart illustrating an example of processing procedures related to request processing to be performed by the information processing device 1 according to the present embodiment. The control unit 11 of the information processing device 1 executes commands included in the program 81 held in the storage unit 12. Thus, the information processing device 1 operates as a computer that can execute the following information processing. The control unit 11 is configured to execute the following information processing. The following processing procedures are one example of an information processing method to be executed by the computer. However, the following processing procedures are merely one example, and each step may be changed maximally.

### Ranking

As shown in FIG. 5, in step S101, the control unit 11 acquires the conversation data 20 that is a record of conversation held among the users U. In one example, the conversation data 20 may be composed of the speech data 201 and the image data 203. Thus, the record of conversation may include speech and images. When the conversation data 20 is acquired, the control unit 11 advances the process to step S102.

In step S102, the control unit 11 analyzes the acquired conversation data 20 to determine the rankings 25 of initiative in the conversation among the users U. In one example, the control unit 11 may analyze at least one of the interpersonal relationship 211 between the users U appearing in the conversation data 20, the knowledge amounts 213 of the users U, the speech amounts 215 of the users U, and the utterance characteristics 217 of the users U. The control unit 11 may determine the rankings 25 of initiative in the conversation among the users U based on at least one of the analyzed interpersonal relationship 211, the analyzed knowledge amounts 213, the analyzed speech amounts 215, and the analyzed utterance characteristics 217. When the rankings 25 are determined, the control unit 11 advances the process to step S103.

In step S103, the control unit 11 outputs information related to the results of determination of the rankings 25 of the users U. The output destination and the content of the information to be output may be selected as appropriate depending on the embodiment. In one example, the control unit 11 may store the results of determination of the rankings 25 of the users U in the storage unit 12 or the RAM for use in the process of determining the priority levels 50. When the output process is completed, the control unit 11 terminates the processing procedures related to ranking according to this operation example.

### Request Processing

As shown in FIG. 6, in step S301, the control unit 11 receives requests 30 uttered by the users U. In step S302, the control unit 11 determines whether the requests 30 are received from at least two users U out of the plurality of users U concurrently. When the requests 30 are received from two or more users U concurrently, the control unit 11 advances the process to step S303. When the requests 30 are not received from two or more users U concurrently (i.e., when the request 30 is received from one user U), the control unit 11 advances the process to step S311.

In step S303, the control unit 11 determines the urgency levels 40 of the received requests 30. In step S304, the control unit 11 determines the priority levels 50 of the received requests 30 based on the results of determination of the rankings 25 and the results of determination of the urgency levels 40. In step S305, the control unit 11 causes the agent A0 to process the requests 30 in accordance with the determined priority levels 50. That is, the control unit 11 causes the agent A0 to process the requests 30 in descending order of the priority levels 50. When the processing of the requests 30 from the users U is completed, the processing procedures related to request processing according to this operation example are terminated.

In step S311, the control unit 11 causes the agent A0 to process the received request 30. When the processing of the received request 30 is completed, the processing procedures related to request processing according to this operation example are terminated. In response to the reception of the requests 30 from the users U in the process of step S301, the control unit 11 may execute the processes of steps S303 to S305 or the process of step S311 in real time.

### Features

According to the present embodiment, the rankings 25 of initiative in the conversation among the users U can be determined by the processes of steps S101 and S102. In the process of step S304, the results of determination of the rankings 25 are used. Therefore, when the requests 30 are received from two or more users U concurrently, the priority levels 50 of the requests 30 received from the users U can be determined appropriately. As a result, it can be expected that the requests 30 received from the two or more users U concurrently are processed in an appropriate order in the process of step S305.

### 4. Modifications

While the embodiment of the present disclosure has been described in detail above, the above description is merely illustrative of the present disclosure in all respects. The processes and means described in the present disclosure can be freely combined and implemented as long as no technical contradiction occurs. In the above embodiment, various improvements or modifications may be made as appropriate.

Regarding the processing procedures of the information processing device 1, steps may be omitted, replaced, or added as appropriate depending on the embodiment. For example, the process of step S303 may be omitted. In response to this, in step S304, the control unit 11 may determine the priority levels 50 of the received requests 30 based on the results of determination of the rankings 25.

What is claimed is:

1. An information processing device comprising a control unit configured to execute:
acquiring conversation data that is a record of conversation held among a plurality of users;
analyzing the acquired conversation data to determine rankings of initiative in the conversation among the users;
when requests are received from at least two users out of the plurality of users concurrently, determining priority levels of the received requests based on results of determination of the rankings; and
causing an agent to process the requests in accordance with the determined priority levels.

2. The information processing device according to claim 1, wherein:
the analyzing of the conversation data includes analyzing at least one of an interpersonal relationship between the users appearing in the conversation data, knowledge amounts of the users, speech amounts of the users, and utterance characteristics of the users; and
the rankings of initiative in the conversation among the users are determined based on at least one of the analyzed interpersonal relationship, the analyzed knowledge amounts, the analyzed speech amounts, and the analyzed utterance characteristics.

3. The information processing device according to claim 1, wherein the record of the conversation includes speech and images.

4. The information processing device according to claim 1, wherein:
the control unit is further configured to execute determining urgency levels of the received requests; and
the determining of the priority levels of the received requests based on the results of determination of the rankings includes determining the priority levels of the received requests based on the results of determination of the rankings and results of determination of the urgency levels.

5. A non-transitory storage medium storing a program for causing a computer to execute an information processing method, the information processing method comprising:
acquiring conversation data that is a record of conversation held among a plurality of users;
analyzing the acquired conversation data to determine rankings of initiative in the conversation among the users;
when requests are received from at least two users out of the plurality of users concurrently, determining priority levels of the received requests based on results of determination of the rankings; and
causing an agent to process the requests in accordance with the determined priority levels.
